(19) United States
(12) Patent Application Publication
(10) Pub. No.: US 2005/0055698 A1
(43) Pub. Date: Mar. 10, 2005

(54) Server-driven data synchronization method and system

(75) Inventors: Takeshi Sasaki, Tokyo (JP); Masato Inoue, Tokyo (JP); Akio Kita, Tokyo (JP)

Correspondence Address: KENYON & KENYON, 1500 K STREET, N.W., SUITE 700, WASHINGTON, DC, 20005, US

(73) Assignee: SAP Aktiengesellschaft

(21) Appl. No.: 10/658,269

(22) Filed: Sep. 10, 2003

(51) Int. Cl. G06F 15/16

(52) U.S. Cl. 719/310

(57) ABSTRACT

A method and system for synchronizing data between a network server and a mobile device is provided. An object instance may be replicated in response to a replication request received from the network server, and a notification message may be created. The notification message may be sent to the mobile device in response to a polling request received from the mobile device, and the replicated object instance may be sent to the mobile device in response to a synchronization request received from the mobile device.

### RELATED APPLICATION(S)

This application is related to U.S. Non-Provisional patent application Ser. No. 10/608,537, filed on Jun. 30, 2003 and entitled “Data Synchronization Method and System.”

### TECHNICAL FIELD

The present invention relates to a data synchronization method and system. More particularly, the present invention relates to a method and system for synchronizing data between a network server and a mobile device.

### BACKGROUND OF THE INVENTION

Enterprise systems manage many of the business processes and applications critical to the success of any particular company, including, for example, order generation and sales activities, inventory management, customer relations and support, product lifecycle and human resources management, etc. Typically, large-scale enterprise systems include one or more enterprise servers and hundreds, if not thousands, of stationary and mobile devices, such as, for example, personal digital assistants (PDAs), pocket computers (Pocket PCs), laptop, notebook and desktop computers, etc. Enterprise systems may also include other components, such as, for example, middleware servers, software application development, deployment and administration subsystems, intra-networks, etc.

Generally, mobile business application functionality may be distributed between an enterprise server and a mobile device based on many different criteria, including, for example, the specific requirements of the particular business application, the processing and storage capacities of the mobile devices, etc. In many cases, business application data may be created, modified and deleted by both the mobile device and the enterprise server. Enterprise business applications typically store data as objects, records, etc., within an application database on the enterprise server. A much smaller subset of these data objects may be duplicated and stored on the mobile device. Consequently, maintaining the consistency of business application data between the mobile device and the enterprise server is an important component of the enterprise system. Due to the transient nature of the network connection between the mobile device and the enterprise sever, an intermediate subsystem, such as, for example, a middleware or synchronization server, may assist the data synchronization process.

For example, a synchronization server may receive and store data updates from the mobile device, and then periodically send these data updates to the enterprise server. Conversely, the synchronization server may periodically request and store data updates from the enterprise server, and then send these data updates to the mobile device when requested. Consequently, data modified by the enterprise server may become inconsistent with data maintained by the synchronization server until the synchronization server requests a data update from the enterprise server, particularly if these data updates are infrequently requested by the synchronization server. Similarly, data updated on the synchronization server may become inconsistent with data maintained by the mobile device until the mobile device requests a data update from the synchronization server. However, if the mobile device does not request a data update from the synchronization server, the data modifications may never be propagated from the enterprise server, through the synchronization server, to the mobile device. Furthermore, even if the mobile device requests a data update from the synchronization server, data inconsistencies may arise if the data updates are infrequently, or unpredictably, requested by the synchronization server.

### SUMMARY OF THE INVENTION

Embodiments of the present invention provide a method and system for synchronizing data between a network server and a mobile device. An object instance may be replicated in response to a replication request received from the network server, and a notification message may be created. The notification message may be sent to the mobile device in response to a polling request received from the mobile device, and the replicated object instance may be sent to the mobile device in response to a synchronization request received from the mobile device.

### BRIEF DESCRIPTION OF THE DRAWINGS

FIG. 1 is a diagram of an enterprise system architecture, according to an embodiment of the present invention.

FIG. 2 is a detailed diagram illustrating a business object and associated business object interface, according to an embodiment of the present invention.

FIG. 3A is a detailed diagram illustrating several business objects, according to an embodiment of the present invention.

FIG. 3B is a detailed diagram illustrating several synchronization business objects, according to an embodiment of the present invention.

FIG. 3C is a detailed diagram illustrating several updated synchronization business objects, according to an embodiment of the present invention.

FIG. 4 is a top level flow diagram illustrating a method for synchronizing data between a network server and a mobile device, according to an embodiment of the present invention.

### DETAILED DESCRIPTION

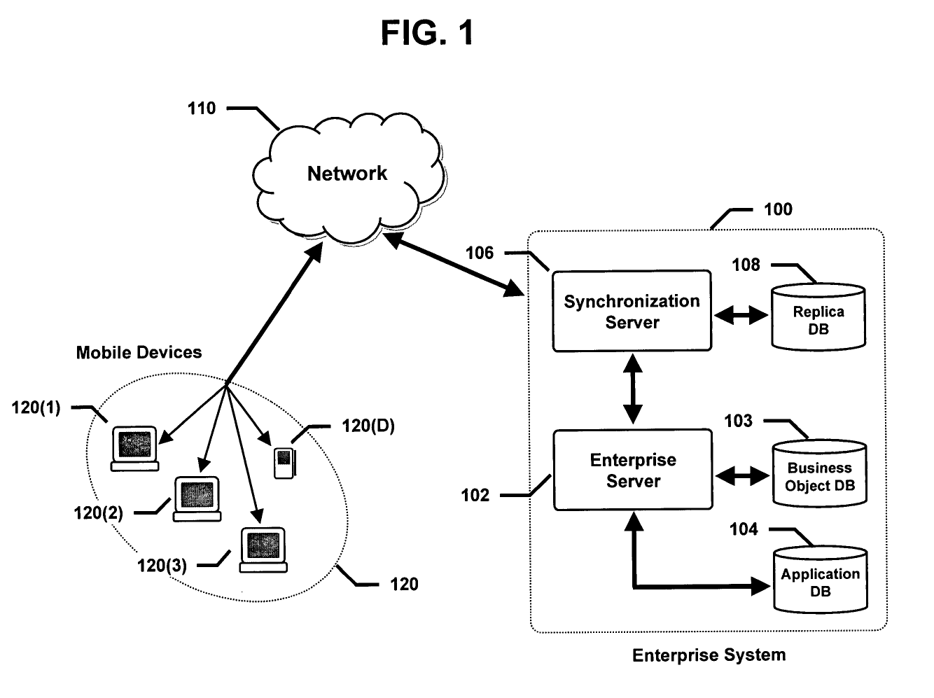

FIG. 1 is a diagram of an enterprise system architecture, according to an embodiment of the present invention.

Enterprise system 100 may include at least one enterprise server 102 coupled to business object database 103 and application database 104, and at least one synchronization server 106 coupled to at least one replica database 108. Enterprise system 100 may support large scale business applications, involving hundreds, if not thousands, of local and remote users, or clients. Generally, mobile business application functionality may be distributed between enterprise system 100 and plurality of mobile devices 120. Various data acquisition functions, such as, for example, order and invoice generation, service notification, etc., may be performed by mobile device 120(1), mobile device 120(2), etc., while other data management activities, such as product lifecycle management, may be performed by enterprise system 100.

At least a portion of the information created and maintained by enterprise system 100 often needs to be provided to each of the plurality of mobile devices 120 in order to support the mobile business application functionality apportioned to these devices. Similarly, information created or modified by each of the plurality of mobile devices 120 may need to be provided to enterprise system 100. Advanced mobile business applications may employ object oriented approaches to data management, including the use of object classes, object instances, etc.

Various embodiments of the present invention provide a synchronization server (e.g., synchronization server 106) to synchronize object-oriented data between enterprise server 102 and plurality of mobile devices 120. For example, synchronization server 106 may receive periodic, or aperiodic, data updates from enterprise server 102. These data updates may include instances of various object classes, several of which may be related to one another. For example, an object instance may include a reference to another object instance, and a hierarchy of object instances may be used by the mobile business application. However, not all these object instances may need to be sent to plurality of mobile devices 120. In one embodiment, an object instance may be selected by synchronization server 106, and the remaining object instances may be recursively searched to identify object instances that may be related to the selected object instance. The related object instances may be sorted and then sent from synchronization server 106 to one, or more, of the plurality of the mobile devices 120. The selected object instance may then be sent from synchronization server 106 to on, or more, the mobile device.

Enterprise server 102 may be a symmetric multiprocessing (SMP) computer, such as, for example, an IBM eServer™ zSeries™ 900, manufactured by International Business Machines Corporation of Armonk, N.Y., a Sun Enterprise™ 10000 server, manufactured by Sun Microsystems of Santa Clara, Calif., etc. Business object database 103 and application database 104 may reside on one or more disks, or disk farms, coupled to enterprise server 102, or, alternatively, to network 110.

Synchronization server 106 may also be a symmetric multiprocessing (SMP) computer, similar to enterprise server 102, and replica database 108 may reside on one or more disks, or disk farms, coupled to synchronization server 106, or, alternatively, to network 110. Generally, enterprise system 100 may be coupled to network 110. In one embodiment, synchronization server 106 and enterprise server 102 may be coupled to network 110, while in another embodiment, synchronization server 106 may be coupled to network 110, and enterprise server 102 may be coupled to synchronization server 104 via a virtual private network, a local area network, a wide area network, etc.

Network 110 may include any type or combination of public or private, wired or wireless networks including, for example, a local area network (LAN), a wide area network (WAN), a virtual private network (VPN), the Internet, etc. Various combinations and layers of network protocols may operate over network 110, including, for example, Ethernet (i.e., IEEE 802.3 CSMA/CD Ethernet), Wireless LAN (e.g., IEEE 802.11, IEEE 802.16, ETSI HYPERLAN/2, Bluetooth, General Packet Radio Service or GPRS, etc.), Transmission Control Protocol/Internet Protocol (TCP/IP), Asynchronous Transfer Mode (ATM), etc. Enterprise system 100 may communicate with plurality of mobile devices 120, i.e., mobile device 120(1), 120(2), 120(3) . . . 120(D), via network 110. Various well-known authentication and data encryption techniques may be used to preserve an appropriate level of security in the public network context, including, for example, HTTPS (HyperText Transfer Protocol with Secure Sockets Layer), etc.

Plurality of mobile devices 120 may include, for example, notebook or laptop computers (e.g., IBM Thinkpad® T Series Notebook), pocket computers (e.g., HP iPAQ Pocket PC h5450s manufactured by Hewlett-Packard of Palo Alto Calif.), personal digital assistants or PDAs (e.g., Palm Tungsten™ T Handhelds manufactured by Palm, Inc. of Milpitas Calif.), smart cellular phones, etc. An operating system may also be provided for each mobile device, such as, for example, Palm OS 5, or any one of a number of Microsoft® Windows® operating systems manufactured by Microsoft Corporation of Redmond Wash., including, for example, Windows® 2000, Windows® XP, Windows® XP Embedded, Windows® CE .NET, Windows® Pocket PC 2002, etc. Each of the plurality of mobile devices 120 may also include mobile application software. In an embodiment, mobile application software may include various functional layers, such as, for example, a user interface layer (UIL) or presentation layer, a business object layer (BOL), a business document layer (BDL) or transaction layer (TL), etc.

In addition to the operating system, each of the plurality of mobile devices 120 may include other software components to support mobile application software, such as, for example, a browser (e.g., Microsoft® Internet Explorer, etc.), microbrowser or native user interface, a web server, a servlet engine, runtime interpreters, extended Markup Language (XML) parsers, data exchange interfaces (e.g., Simple Object Access Protocol, or SOAP, interface, etc.), authentication and encryption components, hardware device drivers, etc. In an embodiment, one, or more, of these runtime components may facilitate data acquisition, transfer and management between the mobile device and enterprise system 100. For example, a Runtime Framework (RF) may include several software components to provide various enterprise-related services to the mobile software application. These components may be accessed, for example, through an Application Programming Interface (API) associated with the Runtime Framework.

In one embodiment, the Runtime Framework may include various Java-based technologies, such as, for example, Java™ Virtual Machine (JVM), Java™ Server Pages (JSP), Java™ 2 Platform, Micro Edition (J2M™), etc. In another embodiment, the Runtime Framework may include other mobile or embedded technologies, such as, for example, Microsoft® NET technologies, Microsoft® eMbedded Visual Basic®, Microsoft® eMbedded Visual C++®, etc. Generally, mobile application software may be organized as runtime objects (ROs) representing executable code embodying various physical and logical constructs, such as, for example, data structures, function calls, procedures, object-oriented classes, etc. Executable code may reside on the mobile device in various forms, such as, for example, HTML files, Dynamic Link Libraries (DLLs), Visual Basic Application (VBA) files, etc. Each of the plurality of mobile devices 120 may include memory to store these runtime objects, as well as memory to store a local database, which may include data associated with the mobile application software.

Each of the plurality of mobile devices 120 may include a network interface to connect to network 110, such as, for example, a coaxial cable interface, a fiber-optic interface, a wireless network interface, etc. Plurality of mobile devices 120 may support an on-line operating mode when connected to network 110, and an off-line operating mode when not connected to network 110. Data integrity, consistency and security may be provided, generally, by complementary synchronization processes executing on enterprise system 100 and each of the plurality of mobile devices 120.

In one embodiment, the enterprise synchronization process may be performed by enterprise server 100, while in another embodiment, and as noted above, synchronization server 106 may provide the enterprise synchronization process. In one embodiment, the mobile synchronization process may be included within the Runtime Framework, while in another embodiment, the mobile synchronization process may be an additional component executing on each mobile device. For example, the mobile synchronization process may include Sun JDBC™ technology and employ HTTPS over the network interface.

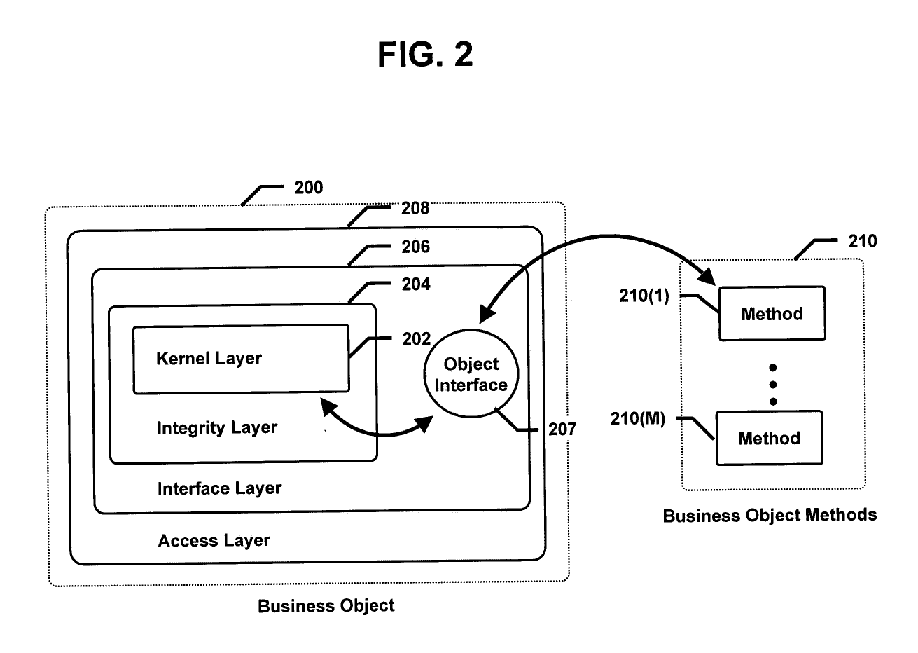

FIG. 2 is a detailed diagram illustrating a business object, according to an embodiment of the present invention.

Enterprise system 100, as well as plurality of mobile devices 120, may include software components expressing the functionality and dependencies of various business processes and data, typically architected according to well-known object-oriented programming (OOP) methods and constructs. Generally, these software components may include application programs and databases, interface libraries, etc., developed, in many cases, using object-oriented software development tools, such as, for example, SAP Software Development Kit (SDK Version 6.2, manufactured by SAP AG of Walldorf, Germany), etc.

In an embodiment, enterprise server 102 may include a plurality of business objects which encapsulate various business methods and data specific to enterprise system 100, while hiding structure and implementation details from higher-level software components, such as, for example, business applications. Generally, business objects may include data definitions, methods, operational rules and constraints, access specifications, etc., that are particular to a specific business component, process, logical construct, etc. Various interfaces may be defined to provide access to the methods and data associated with a particular business object, such as, for example, business application programming interfaces, or “BAPIs”.

Each business object may be created as an instance of a business object type. For example, each employee of a company may be represented by an instance of an Employee business object type. Business object types may be stored within a business object repository (BOR), such as, for example, business object database 103, etc., while business objects (also known as business object instances, object instances, etc.) may be stored within a different database, such as, for example, application database 104, etc. In an embodiment, business object 200 may include kernel layer 202, integrity layer 204, interface layer 206 and access layer 208.

Kernel layer 202 may include data inherently associated with business object 200. For example, an employee business object may include data representing an employee identification number, name, supervisor, business division, etc. Integrity layer 204 may include rules and constraints associated with the environment. Interface layer 206 may describe the implementation and structure of the various methods associated with business object 200, and may include one or more associated interfaces, such as, for example, business object interface 207. Access layer 208 may define various technologies that may be used to access business object 200, such as, for example, COM/DCOM (component object model/distributed component object model), RFC (remote function call), JAVA, CORBA (common object request broker architecture), etc.

In an embodiment, plurality of business object methods 210, i.e., business object method 210(1) . . . 210(M), etc., may also provide access to, or operate upon, data defined within kernel layer 202 of business object 200. In this embodiment, plurality of business object methods 210 may be constructed as function modules compatible with the Remote Function Call (RFC) protocol. Each function module may also be associated with a corresponding business object interface, such as, for example, business object interface 207. Plurality of business object methods 210 may be stored within a business object repository, such as, for example, business object database 103, etc., or, alternatively, plurality of business object methods 210 may be stored within a different database, memory, etc.

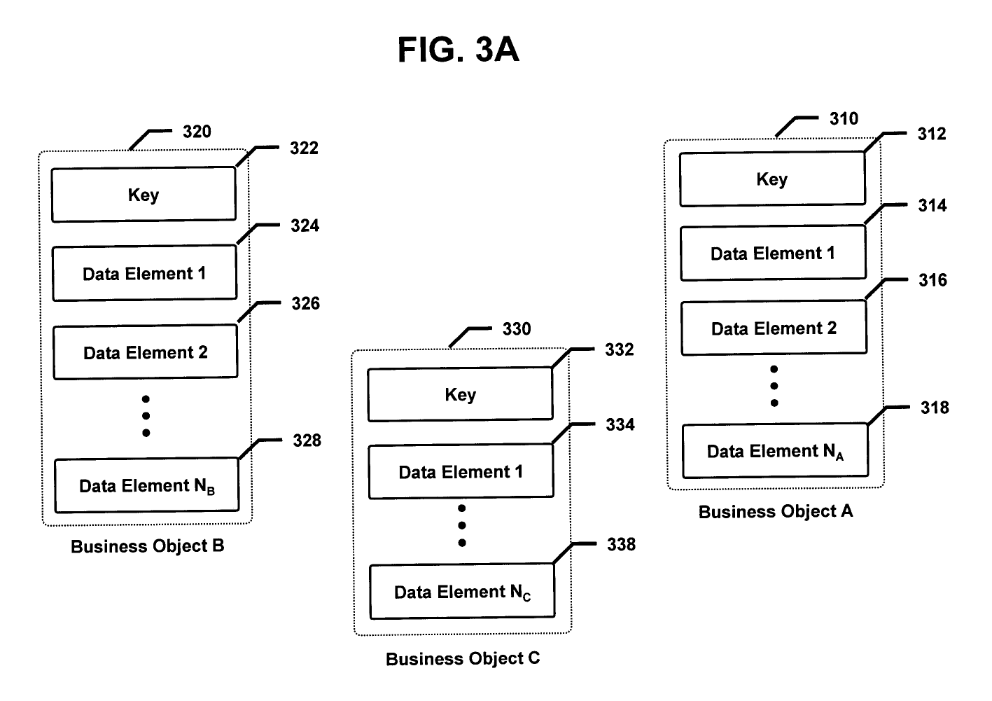

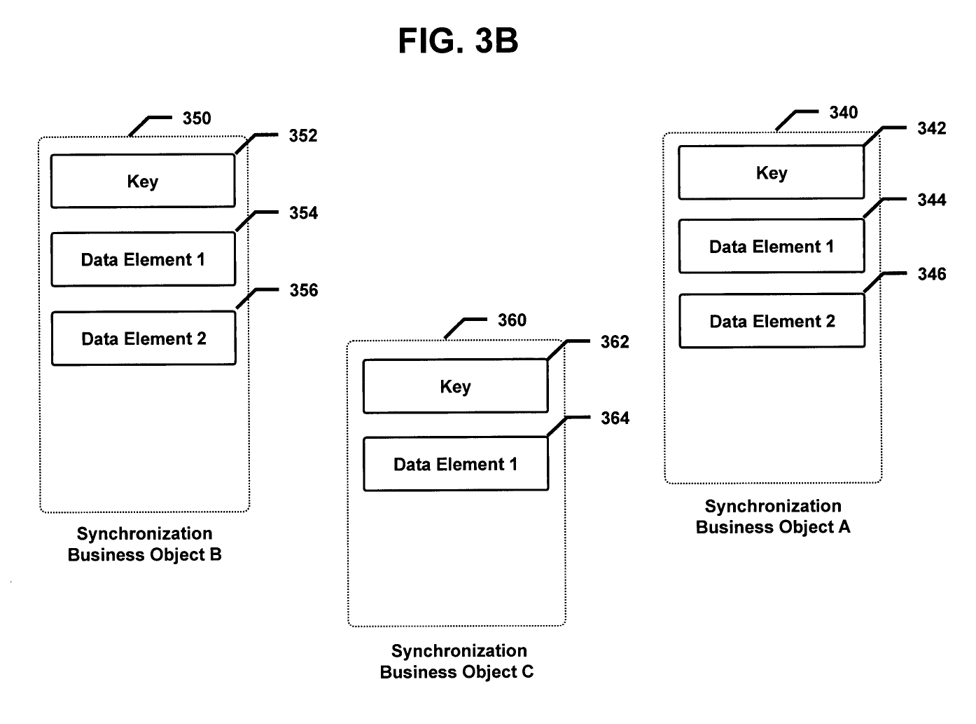

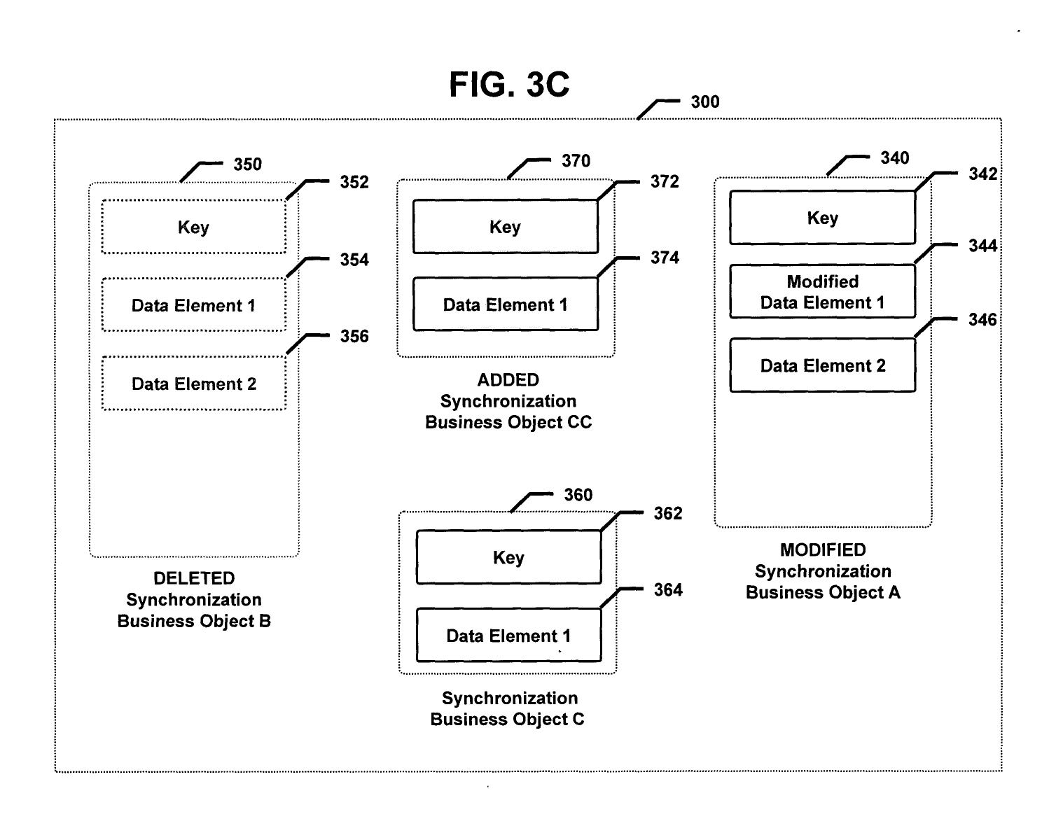

FIG. 3A is a detailed diagram illustrating several business objects, according to an embodiment of the present invention.

As discussed above, the functionality of a mobile business application may be apportioned between enterprise server 102 and plurality of mobile devices 120, and may, generally, consist of various methods and processes operating on business application data. These data may be shared between enterprise server 102 and plurality of mobile devices 120. For example, a sales application may include one or more processes executing on enterprise server 102, as well as one or more processes executing on plurality of mobile devices 120. Enterprise server 102 may create, modify and store large volumes of business application data within application database 104, such as, for example, sales orders, customer information, etc., while each of the plurality of mobile devices 120 may create, modify and store a much smaller volume of these data locally, including, for example, sales orders.

In an embodiment, the mobile business application may operate upon business application data defined by various business object types, such as, for example, business object type A, business object type B, business object type C, etc. As discussed above, each business object type may express data associated with a physical or logical construct related to a particular business process, such as, for example, sales orders, customers, etc., while each business object may define a specific instance of a particular business object type, such as, for example, a single sales order, a single customer, etc. In one embodiment, each business object may include a plurality of data fields, while in another embodiment, each business object may include at least one key as well as several data elements 1 . . . N. The key may facilitate identification of each specific instance of a particular business object type. As discussed above with reference to FIG. 2, these data may be accessed through business application programming interfaces, or BAPIs. Alternatively, these data may be accessed through business application programming interface wrappers, or BAPI Wrappers, which may add additional rules and functionality to business application programming interfaces.

In one example, a mobile business application may employ three business objects to store business application data shared between enterprise server 102 and plurality of mobile devices 120. Referring to FIG. 3A, business object 310 may be defined by business object type A, and may include key 312 as well as data elements 314, 316 . . . 318. Business object 320 may be defined by business object type B, and may include key 322 as well as data elements 324, 326 . . . 328. Business object 330 may be defined by business object type C, and may include key 332 as well as data elements 334, 336 . . . 338. In a simple embodiment, enterprise server 102 and plurality of mobile devices 120 may each store a copy of these business objects. Modifications to business objects 310, 320 and 330 may be performed by enterprise server 102, as well as by any of the plurality of mobile devices 120, and may be propagated throughout the system by synchronization server 106.

In one embodiment, synchronization server 106 may periodically request all of the data within business objects 310, 320 and 330 from enterprise server 102, compare these data with the contents of replica database 108, and update replica database 108 with those data that have been modified by enterprise server 102. In another embodiment, synchronization server 106 may periodically request only those data within business objects 310, 320 and 330 that have been modified by enterprise server 102, then update replica database 108 with the modified data. In response to individual requests received from each of the plurality of mobile devices 120, synchronization server 106 may send the modified data to each mobile device.

Similarly, plurality of mobile devices 120 may individually upload modifications to business objects 310, 320 and 330 to synchronization server 106. Synchronization server 106 may update replica database 108 with the modified data, and then send these modified data to enterprise server 102. Modifications performed simultaneously by enterprise server 102 and one or more mobile devices 120(1), 120(2), etc., may be identified by synchronization server 106, and any contentions may be resolved according to any number of rules, such as, for example, choosing enterprise server 102 data, choosing mobile device data, choosing the most recent data, etc.

FIG. 3B is a detailed diagram illustrating several synchronization business objects, according to an embodiment of the present invention.

In an embodiment, enterprise server 102 may operate upon business application data defined by various business object types, while plurality of mobile devices 120 may operate upon business application data defined by various synchronization business object types. Generally, synchronization business object types may define data shared between enterprise server 102 and plurality of mobile devices 120, and each synchronization business object type may include one or more data fields, keys, data elements, etc., corresponding to one or more business object types. Additionally, various methods may be provided to access the data within each synchronization business object type. Each synchronization business object may be created as an instance of a synchronization business object type, similar to business object instances.

In one embodiment, synchronization business object types may be created by an object-oriented software development tool, such as, for example, SAP's Software Development Kit. Using a synchronization business object builder tool (e.g., SAP's SyncBO Builder), a developer may create synchronization business object types based on one or more business object type definitions. In one embodiment, the synchronization business object builder may allow the developer to select various fields from one, or more, business object type definitions, and then automatically generate a synchronization business object type, which may include data structure definitions as well as data access methods. Data access methods may include, for example, replicating an instance of the synchronization business object type from enterprise server 102 to synchronization server 106, downloading an instance of the synchronization business object type from synchronization server 106 to one of the plurality of mobile devices 120, uploading an instance of the synchronization business object type from one of the plurality of mobile devices 120 to synchronization server 106, etc.

In an example, a mobile business application may employ three synchronization business objects to store business application data shared between enterprise server 102 and plurality of mobile devices 120. Synchronization business object type A may include a subset of the data fields within business object type A, such as, for example, a key and two data elements, as well as methods associated with accessing these data. Similarly, synchronization business object type B may include a subset of the data fields within business object type B, as well as methods associated with accessing these data. Similarly, synchronization business object type C may include a subset of the data fields within business object type C, as well as methods associated with accessing these data. In another embodiment, synchronization business object types may include data fields from more than one business object type.

Referring to FIG. 3B, synchronization business object 340 may be defined by synchronization business object type A, and may include key 342 as well as data elements 344 and 346. In this example, key 342, data elements 344 and 346 may correspond to key 312, data elements 314 and 316 of business object 310, respectively. Synchronization business object 320 may be defined by synchronization business object type B, and may include key 352 as well as data elements 354 and 356, corresponding to key 322, data elements 324 and 326, respectively, of business object 320. Synchronization business object 360 may be defined by synchronization business object type C, and may include key 362 as well as data element 364, corresponding to key 332 and data element 334, respectively, of business object 330. Methods associated with these synchronization business object types are not shown for clarity.

In an embodiment, synchronization server 106 and plurality of mobile devices 120 may each store a copy of these synchronization business objects, while enterprise server 102 may store the corresponding business objects. Modifications to synchronization business objects 340, 350 and 360 may be performed by any of the plurality of mobile devices 120, while modifications to business objects 310, 320 and 330 may be performed by enterprise server 102. These modifications may be propagated throughout the system by synchronization server 106. For example, enterprise server 102 may modify data element 314, and, in response to a request, send the modification to synchronization server 106. Synchronization server 106 then updates data element 344 within replica database 108, and, in response to a request from one, or more, of the plurality of mobile devices 120, sends updated data element 344 to the mobile device. Similarly, mobile device 120(1) may modify data element 344, and upload the modification to synchronization server 106. Synchronization server 106 may update data element 344 stored within replica database 108, and then send the modification to enterprise server 102, which updates data element 314 within application database 104.

FIG. 3C is a detailed diagram illustrating several updated synchronization business objects, according to an embodiment of the present invention.

Plurality of synchronization business objects 300 may include, for example, three synchronization business objects A, B and C, as discussed above with reference to FIG. 3B. In an embodiment, synchronization server 106 and plurality of mobile devices 120 may each store a copy of these synchronization business objects, while enterprise server 102 may store the corresponding business objects from which these synchronization business objects were created. Modifications to synchronization business objects 340, 350 and 360 may be performed by any of the plurality of mobile devices 120, while modifications to business objects 310, 320 and 330 may be performed by enterprise server 102. These modifications may be propagated throughout the system by synchronization server 106.

For example, mobile device 120(1) may modify synchronization business object data element 344, and then upload the modification to synchronization server 106. Synchronization server 106 may update data element 344, stored within replica database 108, and then send the modification to enterprise server 102, which may update corresponding business object data element 314 stored within application database 104. In another example, enterprise server 102 may modify business object data element 314, and, in response to an update request from synchronization server 106, send the modified data element 314 to synchronization server 106 in response to an update request from synchronization server 106. Synchronization server 106 then updates synchronization business object data element 344, stored within replica database 108, and, in response to a synchronization request from one, or more, of the plurality of mobile devices 120, sends the updated data element 344 to the mobile device(s). Similarly, enterprise server 102 may delete a business object, or add a new business object. These deletions and additions may then be applied to the corresponding synchronization business objects, such as, for example, deleted synchronization business object 350 (shown in phantom outline), or added synchronization business object 370. For example, synchronization business object CC 370 may be defined by synchronization business object type C.

In an embodiment, synchronization server 106 may periodically send update requests to enterprise server 102. For example, synchronization server 106 may periodically send a single update request to enterprise server 102, encompassing all of the synchronization business objects within replica database 108, or, synchronization server 106 may periodically send a plurality of update requests to enterprise server 102, each one associated with a specific synchronization business object, etc.

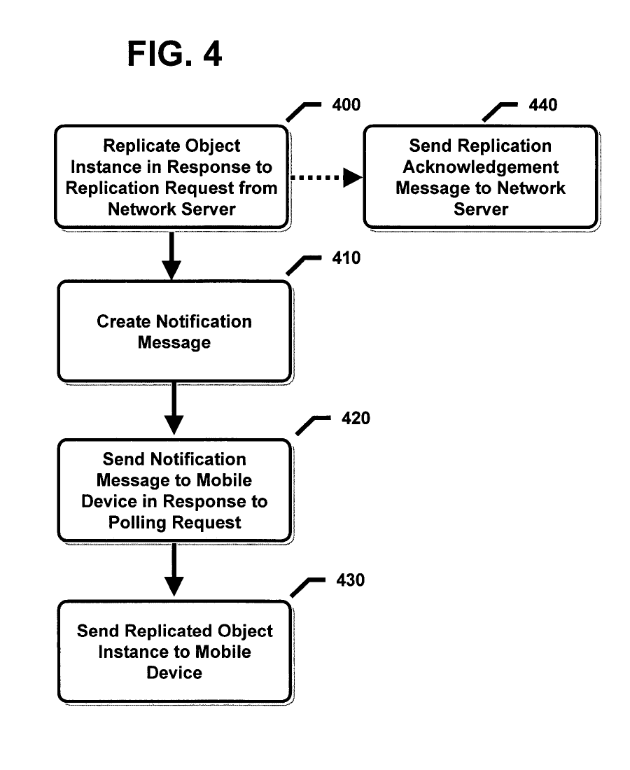

FIG. 4 is a top level flow diagram illustrating a method for synchronizing data between a network server and a mobile device, according to an embodiment of the present invention.

At least one object instance may be replicated (400) in response to a replication request from the network server. In an embodiment, enterprise server 102 may update one, or more, business object data elements, and then send a replication request, identifying the corresponding synchronization business object (i.e., object instance), to synchronization server 106. Advantageously, enterprise server 102 may trigger the replication process as soon as business object data are modified, rather than wait for the next periodic update request from synchronization server 106. Consequently, the impact of data inconsistency between enterprise server 102 and synchronization server 106 may be significantly reduced. Additionally, business object dependencies may be preserved by triggering the replication process only when all of the modifications to each of the dependent business objects have been committed to application database 104.

The replication request may also indicate which mobile device, or devices, may receive the updated data. For example, if a single mobile device is specified within the replication request, all of the synchronization business objects associated with the mobile device may be specified, one or more of the associated synchronization business objects may be specified, etc. In an embodiment, one or more object instance identifiers, as well as one or more mobile device identifiers, may be included in the replication request.

In response to the replication request, synchronization server 106 may determine which synchronization business objects are associated with the replication request, and then replicate (400) the synchronization business object(s). In one embodiment, synchronization server 106 may replicate (400) a synchronization business object by requesting an update, from enterprise server 102, of the identified synchronization business object, such as, for example synchronization business object 340. In response to the update request, enterprise server 102 may send updated synchronization business object data to synchronization server 106. For example, enterprise server 102 may modify data element 314, and then send a replication request to synchronization server 106, identifying synchronization business object 340. In response, synchronization server 106 may replicate synchronization business object 340 by requesting an update of synchronization business object 340 from enterprise server 106, which then sends modified data element 314 back to synchronization server 106 for storage within replica database 108. Synchronization server 106 may request an update, from enterprise server 102, of each synchronization business object identified within the replication request. Updated synchronization business objects may also include new synchronization business objects not yet transferred from enterprise server 102 to synchronization server 106.

In an embodiment, the replication request may cause a remote function call (e.g., general data replication function) to be executed on synchronization server 106, while the update request may cause a remote function call (e.g., general data access routine) to be executed on enterprise server 102. For example, the general data access routine may be a GetList( ) BAPI Wrapper function call that accesses specific data within application database 104, and may be invoked by a data replicator function associated with the synchronization business object. Advantageously, the data replicator function may be automatically generated by a software development tool, such as, for example, the SAP SyncBO Builder tool, when the synchronization business object is created. Accordingly, the generated replicator function may specify the appropriate parameters for the synchronization business object within the remote function call to the general data access routine.

Synchronization business objects may also be deleted. In an embodiment, synchronization server 106 may determine which synchronization business objects are associated with the replication request, and then replicate (400), or, in this case, delete, the synchronization business object from replica database 108.

A notification message may be created (410). In an embodiment, synchronization server 106 may create (410) a notification message in response to the successful replication of a synchronization business object. The notification message may specify which of the plurality of mobile devices may receive the updated data. These mobile devices may be identified by the replication request from enterprise server 102, as described above. In one embodiment, a notification message may be created (410) for each replicated synchronization business object, while in another embodiment, a single notification message may be created (410) for all of the replicated synchronization business objects. In a further embodiment, a single notification message may be associated with each replication request, and, accordingly, may indicate successful replication of each of the synchronization business objects identified by the replication request. The notification message may be stored in a message queue on synchronization server 106, such as, for example, within a message table in dynamic memory, within a database (e.g., replica database 108), etc.

The notification message may be sent (420) to the mobile device in response to a polling request from the mobile device. In an embodiment, synchronization server 106 may receive a polling request from a mobile device (e.g., mobile device 120(1)), and, in response, send (420) the notification message to the mobile device. For example, a polling agent, executing on the mobile device, may periodically send a polling message to synchronization server 106 requesting messages for the mobile device, which may include, of course, the notification message. In response to receiving the notification message, the mobile device may send a synchronization request to synchronization server 106. In one embodiment, all of the messages associated with the mobile device may be sent (420) to the mobile device, while in another embodiment, only the first message in the message queue may be sent (420) to the mobile device.

The replicated object instance may be sent (430) to the mobile device in response to a synchronization request from the mobile device. In an embodiment, synchronization server 106 may receive a synchronization request from a mobile device (e.g., mobile device 120(1)), and, in response, send (430) the replicated synchronization business object, i.e., the new, or modified, object instance, to the mobile device. In one embodiment, the complete synchronization business object may be sent (430) to the mobile device, while in another embodiment, only the updated data within the synchronization business object may be sent (430) to the mobile device. For a deleted object instance, a deletion message may be sent to the mobile device, rather than the replicated object instance.

In a further embodiment, synchronization server 106 may send (440) a replication acknowledgement message to enterprise server 102 after completion of the replication process. An indication of the successful execution of the replication process, or, alternatively, an indication of errors occurring during the replication process, may be included within the notification message. Replication errors may be handled by enterprise server 102, or, alternatively, by synchronization server 106.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for synchronizing data between a network server and a mobile device, comprising:
replicating an object instance in response to a replication request received from the network server;
creating a notification message;
sending the notification message to the mobile device in response to a polling request received from the mobile device; and
sending the replicated object instance to the mobile device in response to a synchronization request received from the mobile device.

2. The method of claim 1, wherein the replication request includes an object instance identifier and a mobile device identifier.

3. The method of claim 2, further comprising:
executing a remote function call in response to the replication request.

4. The method of claim 1, wherein said replicating the object instance includes:
requesting updated data associated with the object instance from the network server;
receiving the updated data associated with the object instance from the network server; and
storing the updated data associated with the object instance in a replica database.

5. The method of claim 4, wherein said requesting updated data includes executing a remote function call, including an object instance identifier, on the network server.

6. The method of claim 4, wherein said sending the replicated object instance to the mobile device includes sending only the updated data associated with the object instance to the mobile device.

7. The method of claim 5, further comprising:
sending a replication acknowledgement message to the network server in response to said storing the updated data.

8. The method of claim 1, wherein said replicating an object instance includes deleting the object instance from a replica database.

9. The method of claim 1, wherein said replicating an object instance includes adding a new object instance to a replica database.

10. A computer-readable medium including instructions adapted to be executed by at least one processor to implement a method for synchronizing data between a network and a mobile device, the method comprising:
replicating an object instance in response to a replication request received from the network server;
creating a notification message;
sending the notification message to the mobile device in response to a polling request received from the mobile device; and
sending the replicated object instance to the mobile device in response to a synchronization request received from the mobile device.

11. The computer readable medium of claim 10, wherein the replication request includes an object instance identifier and a mobile device identifier.

12. The computer readable medium of claim 11, wherein the method further comprises:
executing a remote function call in response to the replication request.

13. The computer readable medium of claim 10, wherein said replicating the object instance includes:
requesting updated data associated with the object instance from the network server;
receiving the updated data associated with the object instance from the network server; and
storing the updated data associated with the object instance in a replica database.

14. The computer readable medium of claim 13, wherein said sending the replicated object instance to the mobile device includes sending only the updated data associated with the object instance to the mobile device.

15. The computer readable medium of claim 13, wherein the method further comprises:
sending a replication acknowledgement message to the network server in response to said storing the updated data.

16. The computer readable medium of claim 10, wherein said replicating an object instance includes deleting the object instance from a replica database.

17. The computer readable medium of claim 10, wherein said replicating an object instance includes adding a new object instance to a replica database.

18. A system for synchronizing data between a network server and a mobile device, comprising:
a processor coupled to a network; and
a memory, coupled to the processor, storing data and instructions adapted to be executed by the processor to:
replicate an object instance in response to a replication request received from the network server;
create a notification message;
send the notification message to the mobile device in response to a polling request received from the mobile device; and
send the replicated object instance to the mobile device in response to a synchronization request received from the mobile device.

19. The system of claim 18, wherein the replication request includes an object instance identifier and a mobile device identifier.

20. The system of claim 19, wherein the processor is further adapted to:
execute a remote function call in response to the replication request.

21. The system of claim 18, wherein said replicate the object instance includes to:
request updated data associated with the object instance from the network server;
receive the updated data associated with the object instance from the network server; and
store the updated data associated with the object instance in a replica database.

22. The system of claim 21, wherein said send the replicated object instance to the mobile device includes to send only the updated data associated with the object instance to the mobile device.

23. The system of claim 22, the processor is further adapted to:
send a replication acknowledgement message to the network server in response to said store the updated data.

24. The system of claim 18, wherein said replicate an object instance includes to delete the object instance from a replica database.

25. The system of claim 18, wherein said replicate an object instance includes to add a new object instance to a replica database.
